(19) United States
(12) Patent Application Publication
(10) Pub. No.: US 2023/0257114 A1
(43) Pub. Date: Aug. 17, 2023

(54) AIRPLANE THAT PERFORMS VERTICAL TAKEOFF WITH A POSITIVE PITCH ANGLE

(71) Applicants: Chung Kiak Poh, Pulau Pinang (MY); Chung How Poh, Pulau Pinang (MY)

(72) Inventors: Chung Kiak Poh, Pulau Pinang (MY); Chung How Poh, Pulau Pinang (MY)

(21) Appl. No.: 18/109,477

(22) Filed: Feb. 14, 2023

(30) Foreign Application Priority Data
Feb. 15, 2022 (MY) PI2022000887

(51) Int. Cl. B64C 29/00; B64C 27/28; B64C 25/10; B64C 27/20; B64C 5/02

(52) U.S. Cl. CPC B64C 29/0033; B64C 27/28; B64C 25/10; B64C 27/20; B64C 5/02

(57) ABSTRACT

This invention relates to an airplane capable of hovering, hyper-short takeoff and landing (hyper-STOL) and vertical takeoff and landing (VTOL) while assuming a positive pitch angle. The airplane comprises at least a pair of wings, at least one vertical propulsor, and at least two horizontal propulsors whose thrust vectors are tiltable with a tilt angle that is adjustable from 0° to 76° relative to the airplane's longitudinal axis when viewed from a side view. The impeller of the vertical propulsor may be fixed-pitch or variable-pitch.

### CROSS REFERENCE TO RELATED APPLICATION

This application claims priority to Malaysian Patent Application No. PI2022000887, filed on Feb. 15, 2022, the contents of which are incorporated herein by reference.

### FIELD OF INVENTION

The present invention relates to an airplane that performs hyper-short/vertical takeoff and landing (hyper-STOL/VTOL) with a positive pitch angle (nose-up attitude).

### BACKGROUND OF INVENTION

Personal aviation and air-taxi services based on fixed-wing aircraft capable of vertical takeoff and landing (VTOL) are gaining attention globally [1]. Many of them are electric-powered and hence the term electric VTOL, or eVTOL for short. Among the types of airframes that may be used to realize such VTOL fixed-wing aircraft are QuadPlanes, tilt-wings and tilt-rotors [2,3,4]. For both the tilt-wings and the tilt-rotors, the thrust vectors of the primary propulsors are tilted through an angle of substantially 900 range from vertical to horizontal as the aircraft transitions from vertical takeoff to horizontal flight with the fuselage being substantially level with the horizon. One may consider the QuadPlane as a combination of a quadcopter [5] and a conventional airplane—it too performs vertical takeoff with its fuselage being substantially level with the horizon.

### SUMMARY OF INVENTION

The present invention relates to a fixed-wing aircraft (airplane) capable of hovering, and vertical takeoff and landing (VTOL) while assuming a generally positive pitch angle (nose-up attitude). Due to its inherent design, the present invention is expected to exhibit a smooth transition from vertical flight to forward flight and this may enhance passenger comfort.

Embodiments of the airplane in the present invention comprise at least one vertical propulsor having a tilt angle with respect to the vertical axis of the airplane when viewed from a side view; at least a pair of wings; and at least two horizontal propulsors whose thrust vectors are tiltable, making a tilt angle with the airplane's longitudinal axis when viewed from a side view. The tiltable angular range of the horizontal propulsor is 0° to 76°. The tilt angle of the vertical propulsor is in the range of 0° to 45°. The tilt angle of the vertical propulsor may preferably be fixed to keep design of the airplane as simple as possible.

As an example, the airplane is able to achieve a hover with a positive pitch angle of 20° (in null wind condition) when: the tilt angle of the thrust vectors of the two horizontal propulsors is 70° measured against the longitudinal axis; and the tilt angle of the thrust vector of the vertical propulsor is fixed at 0° measured against the vertical axis and the vertical propulsor is located on the front section of the airplane, at a physical distance away from the airplane's center of gravity (C.G.). In the present of headwind, the airplane can be expected to hover with a pitch angle of less than 20°. All embodiments in the present invention can also be used as an airplane that is capable of hyper-short takeoff and landing (hyper-STOL) by varying the total horizontal and vertical thrust components.

The airplane's pitch angle as well as longitudinal, lateral and vertical axes follow the standard terminologies in aeronautics and aerodynamics. The vertical propulsor may be of various types, and examples of which are variable-pitch impeller, fixed-pitch propeller, and duct nozzle(s) carrying gas(es) that create(s) reaction thrust.

### BRIEF DESCRIPTION OF THE DRAWINGS

FIG. 1(a) is a perspective view of an exemplary airplane in accordance with the present invention. It comprises a vertical propulsor mounted on the front section of the airplane.

FIG. 1(b) is a side view of the exemplary airplane as shown in FIG. 1(a) when it is performing a hover.

FIG. 1(c) is an illustration of the airplane as shown in FIG. 1(a) in forward flight mode with its wings and horizontal propulsors set to a tilt angle of 0° measured against the airplane's longitudinal axis and having its landing gears and vertical propulsor retracted into its fuselage.

FIG. 1(d) is a side view showing the airplane as in FIG. 1(a) with its wings and horizontal propulsors tilted at a tilt angle of 76° and having its nose landing gear partially extended such that the airplane's longitudinal axis is substantially parallel to the ground.

FIG. 1(e) is a side view showing the airplane as in FIG. 1(a) with its nose landing gear extended such that the airplane's pitch angle is 10°.

FIG. 1(f) shows an embodiment of the airplane in accordance with the present invention wherein the airplane is equipped with two vertical propulsors of fixed-pitch impeller.

FIG. 1(g) shows an embodiment of the airplane in accordance with the present invention wherein the vertical propulsor is ducted.

FIG. 1(h) is a perspective view showing an embodiment of the airplane in accordance with the present invention wherein the vertical propulsor is in the form of a duct nozzle or a plurality of duct nozzles carrying gas(es) to create reaction thrust.

FIG. 1(i) shows another embodiment of the airplane in accordance with the present invention wherein the wings (102) are non-tiltable and only the horizontal propulsors (104) are tiltable, pivoting substantially about the lateral axis.

FIG. 1(j) is a perspective view showing an embodiment of the airplane in accordance with the present invention wherein the axis about which the thrust vectors of the horizontal propulsors (104) tilt does not coincide with the lateral axis.

FIG. 1(k) is a side view of the embodiment as shown in FIG. 1(j).

FIG. 1(l) is a perspective view showing an embodiment of the airplane in accordance with the present invention wherein at least one vertical propulsor (106) is mounted on the back section of the airplane.

FIG. 1(m) is a side view of the embodiment as shown in FIG. 1(l).

FIG. 2(a) is a perspective view of an exemplary airplane in accordance with the present invention wherein the airplane comprises at least one vertical propulsor located on the front section of the airplane, and at least one vertical propulsor located on the back section of the airplane.

FIG. 2(b) is a side view showing the forces acting on the airplane when it is performing a hover in accordance with the present invention.

FIG. 3 is a perspective view showing an embodiment of the airplane in accordance with the present invention in the form of a jet plane wherein adjustment of the tilt angle of the thrust vector of the horizontal propulsor is achieved by using thrust vectoring nozzle.

### DETAILED DESCRIPTION OF THE EMBODIMENTS

The present invention relates to an airplane capable of hovering, and vertical takeoff and landing (VTOL) while assuming a positive pitch angle, i.e., having a nose-up attitude. The airplane may be in the form of a simple flying wing that lacks a fuselage, or it may be one which comprises a distinctive fuselage which can be particularly useful for transport applications.

Embodiments of the airplane comprise an all-up-weight; a center of gravity (C.G.); a front section located in front of the C.G., and a back section located behind the C.G.; a longitudinal axis; a lateral axis; a vertical axis; at least a pair of wings; at least one vertical propulsor; and at least two horizontal propulsors. The longitudinal axis divides the airplane into a left side and a right side. In embodiments, at least one horizontal propulsor is mounted on the left side, and at least one horizontal propulsor is mounted on the right side. The longitudinal and vertical axes rotate with the airplane as it pitches up or down during flight.

Each horizontal propulsor produces a thrust. The thrust vector of the horizontal propulsor is tiltable with a tilt angle that is adjustable in the range of 0° to 76° relative to the longitudinal axis when viewed from a side view. The vertical propulsor produces a thrust. The thrust vector of the vertical propulsor has a tilt angle in the range of 0° to 45° relative to the vertical axis when viewed from a side view. The thrust vector of the vertical propulsor is not parallel to those of the horizontal propulsors during a hover when viewed from a side view in accordance with the present invention.

Adjustment of the tilt angle of the thrust vector of the horizontal propulsor may be achieved using various means, and among them are by tilting of the horizontal propulsor itself and the use of thrust vectoring nozzle.

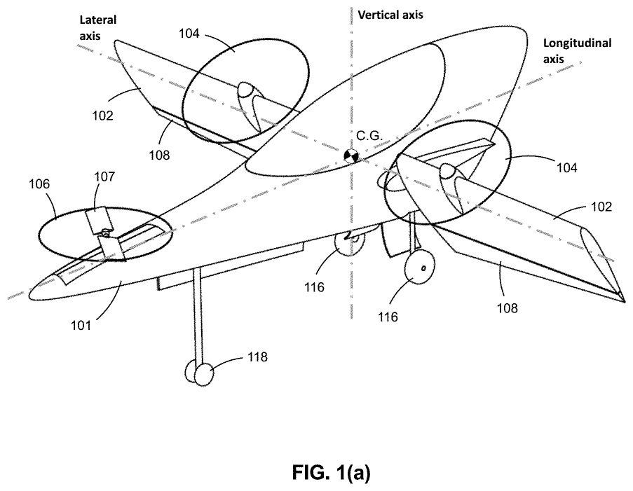

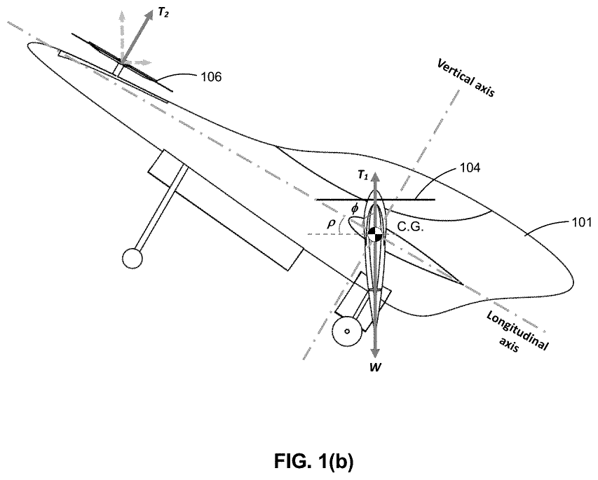

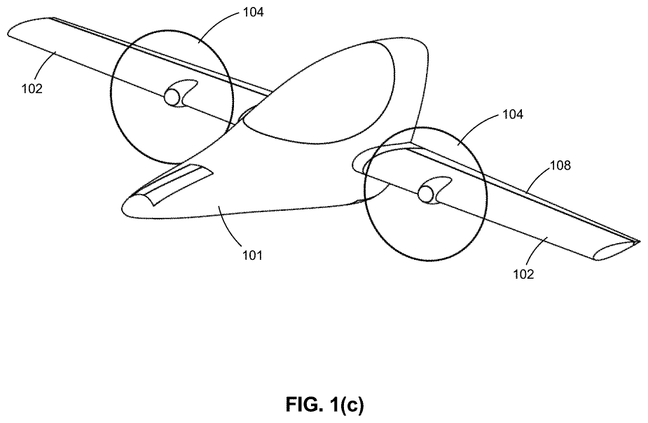

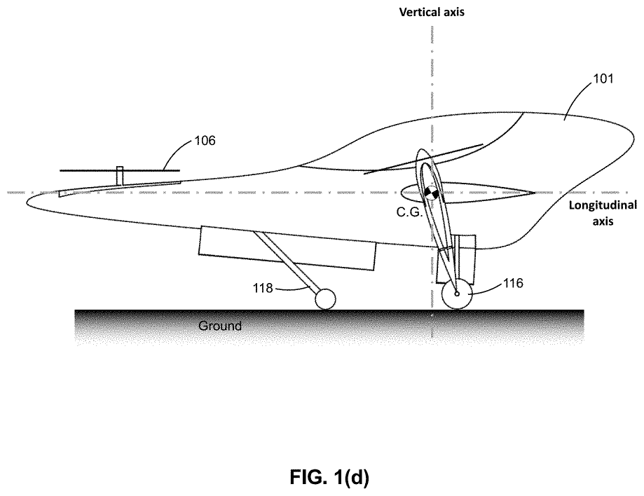

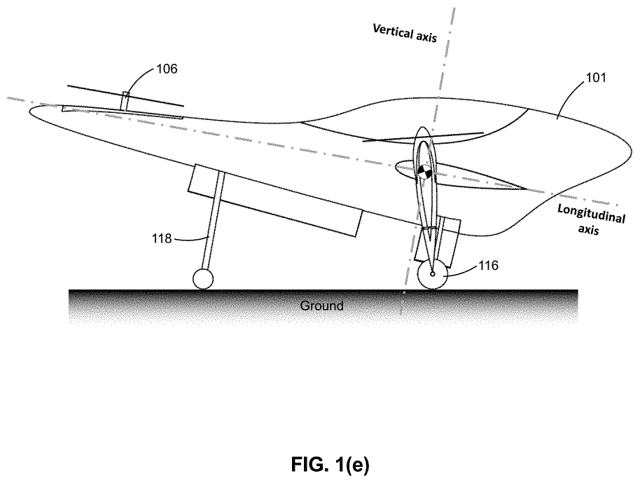

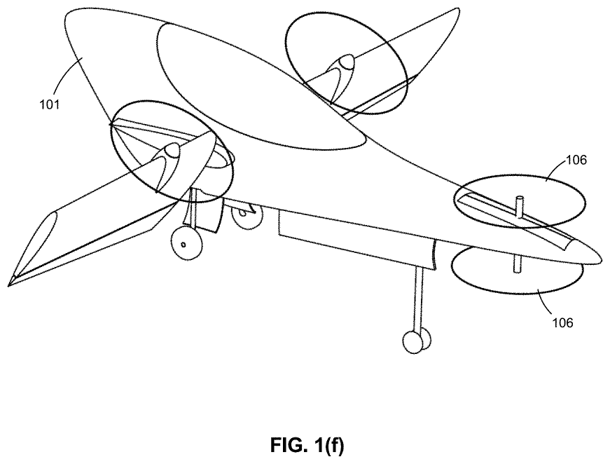

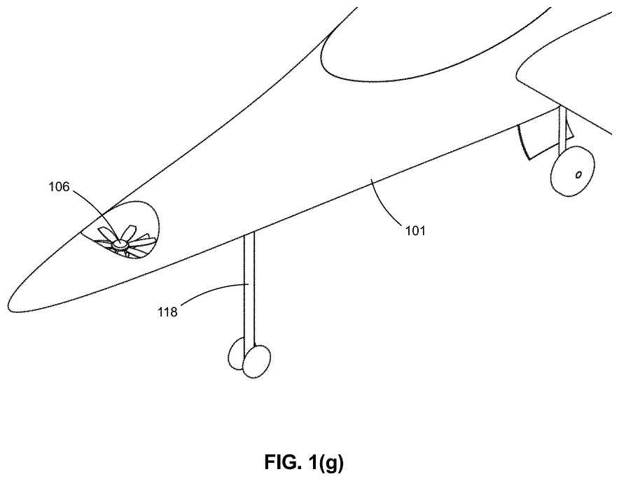

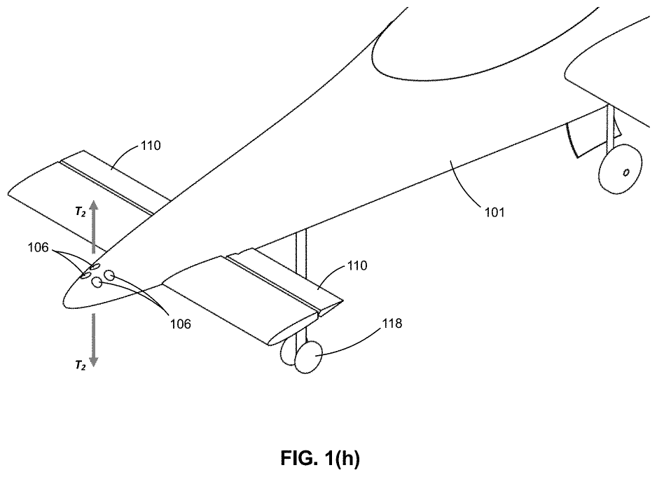

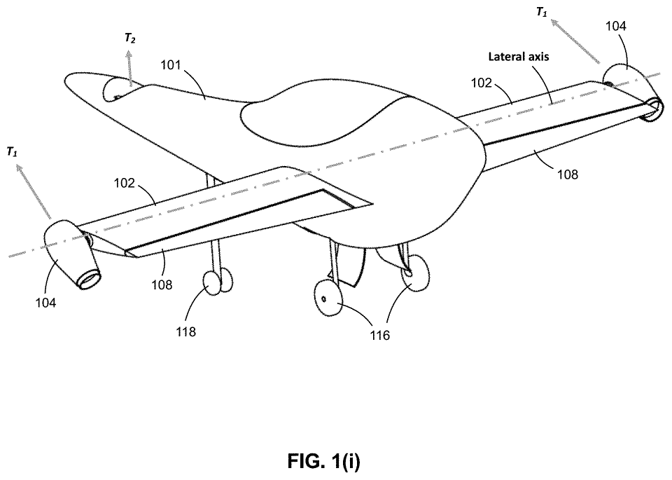

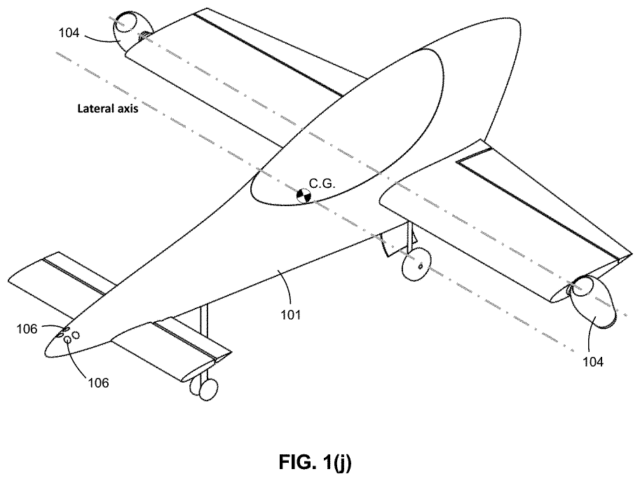

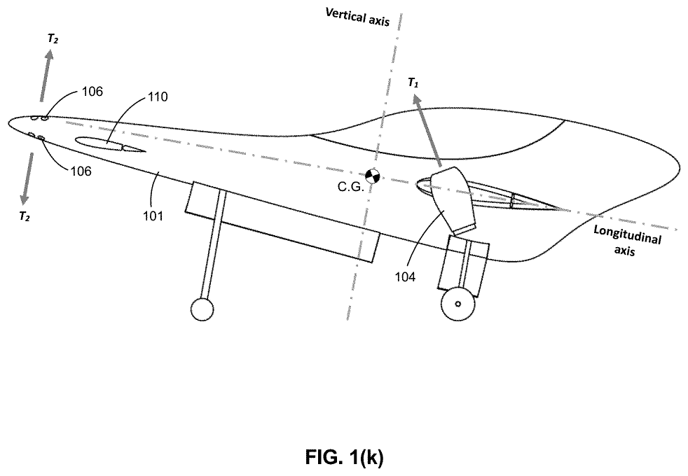

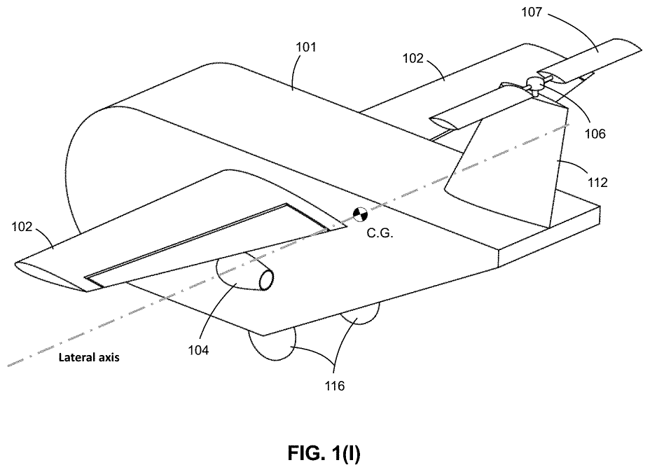

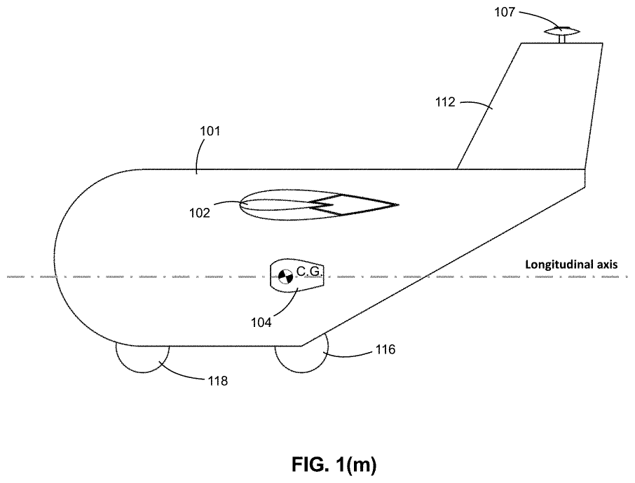

FIG. 1(a) is a perspective view of an exemplary airplane in accordance with the present invention. The airplane comprises an all-up-weight, a center of gravity (C.G.), a fuselage (101), a front section located in front of the C.G., a back section located behind the C.G., a longitudinal axis, a lateral axis, a vertical axis, at least a pair of wings (102), at least two horizontal propulsors (104), and at least one vertical propulsor (106). The longitudinal axis divides the airplane into a left side and a right side. Each wing (102) comprises a chord line. In accordance with the present invention, at least one horizontal propulsor (104) is mounted on the left side, and at least one horizontal propulsor (104) is mounted on the right side, which in this embodiment, at least one horizontal propulsor (104) is mounted on the left wing (102) and at least one horizontal propulsor (104) is mounted on the right wing (102) as shown. Each horizontal propulsor (104) generates a thrust vector, and the thrust vector is substantially parallel to the chord lines of the respective wings (102).

In the exemplary airplane, the wings (102) as well as the thrust vector of the horizontal propulsor (104) tilt substantially about the lateral axis such that the tilt angle of the thrust vector of the horizontal propulsor (104) is adjustable in the range of 0° to 76° relative to the longitudinal axis when viewed from a side view.

In this embodiment, the vertical propulsor (106) is located on the front section of the airplane with a tilt angle fixed at substantially 0° relative to the vertical axis and at a distance away from the C.G. Furthermore, the impeller (107) of the vertical propulsor (106) is of variable-pitch so the vertical propulsor (106) is able to control the pitch of the airplane during takeoff and vertical flights. The vertical propulsor (106) generates a thrust vector that is pointing upward and making a tilt angle of 0° relative to the vertical axis when viewed from a side view.

The exemplary airplane further comprises a set of main landing gears (116) located on the back section of the airplane, behind the C.G. of said airplane; and a nose landing gear (118) located on the front section of the airplane, in front of the C.G. of said airplane. The landing gears (116, 118) may be retractable.

The main landing gears (116) and the nose landing gear (118) may further comprise weigh-measuring means to acquire the value of AUW and location of the C.G. prior to takeoff. To adjust the location of C.G., the airplane may comprise weight-shifting means, for example, moving the battery pack of the horizontal propulsor (104).

Referring now to FIG. 1(b) in order to gain insight into the forces acting on the airplane which make hovering and VTOL flights possible. The exemplary airplane has an all-up-weight (AUW) of W and the airplane is hovering with a pitch angle, p (example, 30° as shown in the figure in null wind condition). The pitch angle is defined as the angle between the longitudinal axis of the airplane and the horizon. Due to the tilting of the wings (102) around the lateral axis as pivot, the thrust vectors of the horizontal propulsors (104) are angled upward with a tilt angle ϕ=60° measured against the longitudinal axis as illustrated in FIG. 1(b).

Furthermore, to achieve a hovering flight in null wind, this exemplary airplane needs the following conditions: each of the horizontal propulsors (104) generates a thrust vector with a magnitude of T₁ and sum of the thrust vectors of the horizontal propulsors (104) equals to the all-up-weight W, i.e. 2·T₁=W; the thrust vector of the horizontal propulsor (104) passes through the C.G. when viewed from a side view; sum of the pitch angle ρ of the airplane and the tilt angle of the thrust vector of the horizontal propulsor (104) ϕ is 90°; and the magnitude of the thrust vector of the vertical propulsor (106) T₂ is zero. The implications of such conditions are that the sum of the thrust vectors of the horizontal propulsors (104) directly supports the all-up-weight W of the airplane, and that the angle between the thrust vectors of the horizontal propulsors (104) and the all-up-weight vector W is 180° as indicated in FIG. 1(b). Other combinations of ϕ and ρ of interest while satisfying the conditions mentioned above are:

ϕ=76° and ρ=14°; and

ϕ=70° and ρ=20°.

From the frame of reference of an observer standing on the ground, T₂ the thrust vector of the vertical propulsor (106) is pointing upward and in a generally backward direction when the airplane is performing hovering and vertical flight as indicated by the grey dotted arrows in FIG. 1(b).

During hovering and VTOL flights, control surfaces such as elevons (108) are used to initiate “roll” while differential thrust between the horizontal propulsors (104) mounted on the left side and the right side of the airplane may be used to initiate yaw control. From FIG. 1(b), it follows that when viewed from a side view during a hovering maneuver in null wind condition, the airplane yaws about an axis which is substantially orthogonal to the thrust vector of the horizontal propulsor (104), and this yaw axis substantially passes through the airplane's C.G. The roll axis during a hover would be substantially orthogonal to the axis about which the airplane yaws and it would substantially pass through the C.G. as well.

FIG. 1(c) is an illustration of the airplane as shown in FIG. 1(b) in forward flight mode with its wings (102) and horizontal propulsors (104) adjusted to a tilt angle of 0°, and having its landing gears (116, 118) and vertical propulsor (106) retracted into its fuselage (101). The elevons (108) are used for conventional pitch and roll controls during forward flight mode. Differential thrust between the horizontal propulsor (104) on each wing (102) may be used for conventional yaw control. Vertical stabilizer with rudder may optionally be added to the airplane.

FIG. 1(d) shows the same airplane with the wings (102) and horizontal propulsors (104) tilted at a tilt angle of 76° and wherein vertical height of the nose landing gear (118) can be adjusted so the pitch angle ρ of the airplane may be adjusted from 0° to 10° when the airplane is on the ground. This is to reduce power load requirement on the vertical propulsor (106) in pitching up the airplane and this is especially so when the longitudinal axis is parallel with the ground or horizon. FIG. 1(e) shows the vertical height of the nose landing gear (118) increasing further compared to FIG. 1(d) resulting in the airplane having a pitch angle of 10°. To achieve vertical takeoff in null wind condition, the vertical propulsor (106) will just have to produce a thrust to increase the pitch angle by another 4°, i.e., 76°+10°+4°=90°.

FIG. 1(f) shows another embodiment of the airplane in accordance with the present invention wherein the airplane is equipped with two vertical propulsors (106) of fixed-pitch impeller; one propulsor pitches the airplane up, the other pitches the airplane down; their thrust vectors are substantially opposing to each other.

FIG. 1(g) shows yet another embodiment of the airplane wherein the vertical propulsor (106) is ducted. FIG. 1(h) shows an embodiment of the airplane in accordance with the present invention wherein the vertical propulsor (106) is in the form of a duct nozzle or a plurality of duct nozzles carrying gas(es) to create reaction thrust with a thrust vector T₂. If the gases are oxygen and hydrogen, then the vertical propulsor (106) will generate thrust similar to a rocket engine. Another possible approach may be for the airplane to carry a cylinder of compressed air. Use of exhaust gas(es) from a turbine engine is also a possibility. Given the compactness of duct nozzle, the airplane may comprise a horizontal stabilizer (110) in canard configuration to control pitch during horizontal flight.

FIG. 1(i) shows another embodiment of the airplane wherein the wings (102) are non-tiltable and only the horizontal propulsors (104) are tiltable, pivoting substantially about the lateral axis with tiltable angular range of 0° to 76° with respect to the longitudinal axis. This embodiment is an example of varying the tilt angle of the thrust vector of the horizontal propulsor (104) by tilting the horizontal propulsor (104) relative to the longitudinal axis. FIG. 1(i) also illustrates the airplane initiating a roll during VTOL by tilting one of the horizontal propulsors (104) upward from the central tilt angle #, and tilting the other horizontal propulsor (104) downward from the central tilt angle #, e.g., 30°+10°, and 30°−10°.

When the horizontal propulsors are tilting by themselves as in FIG. 1(i), this may be regarded as a tilt-rotor configuration in the conventional sense. Likewise, if the horizontal propulsors are mounted on the wings as in FIG. 1(a), then this may be regarded as a tilt-wing configuration in the conventional sense. FIG. 1(j) shows another embodiment of the airplane wherein the axis about which the thrust vectors of the horizontal propulsors (104) tilt does not coincide with the lateral axis but is at a physical distance away on the back section of the airplane. FIG. 1(k) is a side view of the embodiment shown in FIG. 1(j). To retain a hovering flight, vector analysis suggests that as the horizontal propulsors (104) move further away from the C.G. as shown in FIG. 1(k):
T₂ thrust vector of the vertical propulsor (106) needs to increase in magnitude;
A reduction in the pitch angle of the airplane; and
T₁ thrust vector of the horizontal propulsor (104) needs to decrease in magnitude.

FIG. 1(l) shows an embodiment of the present invention wherein at least one vertical propulsor (106) is mounted on the back section of the airplane at a distance from the C.G. The tilt angle of the vertical propulsor (106) is fixed at substantially 0° relative to the vertical axis.

In this exemplary embodiment, one vertical propulsor (106) is mounted on top of a vertical stabilizer (112). Furthermore, the impeller (107) of the vertical propulsor (106) may be of variable-pitch and having airfoil cross-section of elliptical in shape. FIG. 1(m) is a side view, and it shows the elliptical airfoil of the impeller (107). This permits the vertical propulsor (106) to be at rest during horizontal flight and the impeller (107) may function as horizontal stabilizer to control or augment pitch of the airplane.

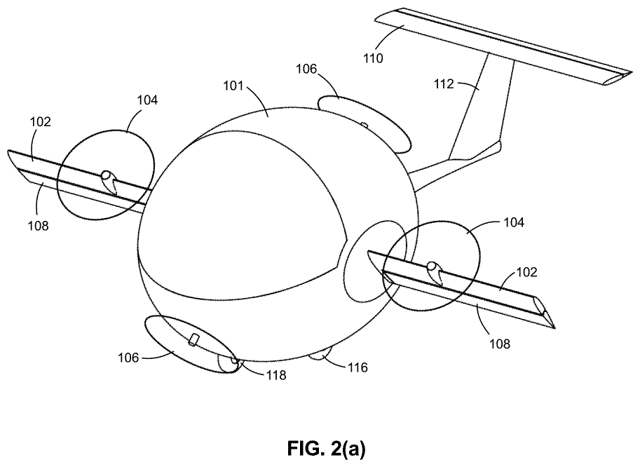

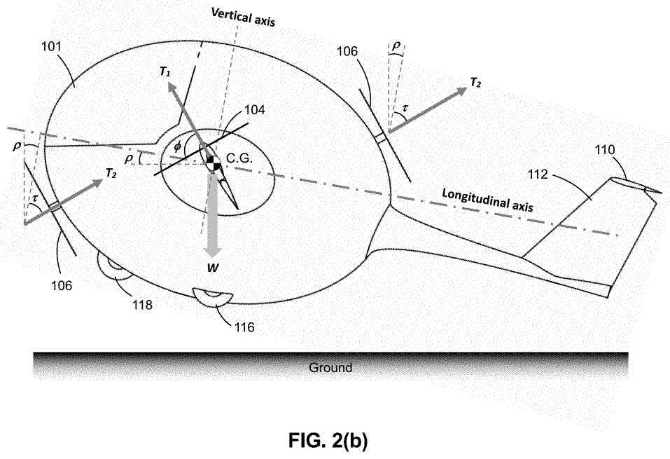

The present invention comprises at least a vertical propulsor (106). So far, we have presented embodiments wherein at least one vertical propulsor (106) is mounted on the front or back section of the airplane in accordance with the present invention. FIG. 2(a) is a perspective view of an exemplary airplane in accordance with the present invention wherein the airplane comprises at least one vertical propulsor (106) located on the front section of the airplane, and at least one vertical propulsor (106) located on the back section of the airplane. It also comprises a fuselage (101). Excluding the tail section, the shape of the fuselage (101) is generally an ellipsoid, and this shape is to cater for the rather unique arrangement of its vertical propulsors (106).

In this exemplary airplane, at least one horizontal propulsor (104) is mounted on each side of the wings (102) wherein the thrust vectors of the horizontal propulsors (104) are substantially parallel to the chord lines of the respective wings (102). The wings (102) have symmetrical airfoil. The horizontal propulsors (104) may be based on a variety of drives such as electric motor, turbine engines, internal combustion, and solar engine. Both the vertical propulsors (106) are preferably located at substantially equal distance from the C.G. for optimal pitch control performance. Furthermore, the tandem vertical propulsors (106) in this example are counter-rotating to each other to cancel out the torque effect.

During hovering and vertical flight, the horizontal propulsors (104) and the vertical propulsors (106) contribute to lift via resolution of vectors. Depending on whether the airplane is performing VTOL or in horizontal flight, the tilt angle of the thrust vector of the horizontal propulsors (104) is adjustable from a minimum of 0° to a maximum of 76° measured against the longitudinal axis of the airplane in accordance with the present invention.

This exemplary airplane comprises at least an aerodynamic surface for pitch stability and control during horizontal flight mode in the form of a horizontal stabilizer (110). Optionally, the airplane may comprise at least one vertical stabilizer (112) which is particularly useful for directional stability during a glide or in case the horizontal propulsors (104) are malfunctioning and differential thrust for yaw control is not available.

A set of main gears (116) is located on the back section of the airplane, behind the C.G. of said airplane. Main landing gears (116) and nose gear (118) with wheels are useful for hyper-STOL and emergency landing involving ground roll on runway.

Referring now to FIG. 2(b) in order to gain insight into the forces acting on the airplane which make hovering and VTOL flights possible. The airplane is hovering with a pitch angle of ρ. Each of the horizontal propulsors (104) generates a thrust vector of magnitude T₁. The thrust vectors of the horizontal propulsors (104) are angled upward by an amount ϕ measured against the longitudinal axis as seen from a side view and this results in a vertical thrust component. The thrust vectors of the vertical propulsors (106) are angled backward by a tilt angle τ measured against the vertical axis. The tilt angle τ may range from a minimum of 0° to a maximum of 45°.

During a hover, the airplane yaws about an axis which is substantially orthogonal to the thrust vector of the horizontal propulsor (104), and the yaw axis substantially passes through the airplane's C.G when viewed from a side view as in FIG. 2(b).

Each of the vertical propulsors (106) generates a thrust of T₂. The airplane has an all-up-weight (AUW) of W. For ease of illustration, let's consider a scenario in which T₂=T₁.

Considering the horizontal components of the forces when the airplane is hovering with no environmental wind, one obtains

T₁·cos(ρ+ϕ)=T₂·sin(ρ+τ).

Now, considering the vertical components of the forces, one obtains

T₁·sin(ρ+ϕ)+T₂·cos(ρ+τ)=0.5×W.

In case of ϕ=35°, and τ=35° then ρ=10°.

⇒T₁=T₂=0.3536W.

Taken together, the vector analysis shows that when the pitch angle ρ is 10° and when the horizontal propulsors (104) and the vertical propulsors (106) produce the same amount of thrust, i.e. T₁=T₂=0.3536W, stationary hover is attained. A way to achieve hyper-STOL is simply by increasing the ratio of T₁/T₂.

Among the notable and interesting results from vector analysis are as follow:

| | | | | |
|---|---|---|---|---|
| 1. | ϕ = 45° | τ = 45° | ρ = 0° | T₁ = T₂ = 0.3536 W |
| 2. | ϕ = 45° | τ = 45° | ρ = 10° | T₁ = 0.4096 W, T₂ = 0.2868 W |
| 3. | ϕ = 45° | τ = 45° | ρ = 15° | T₁ = 0.433 W, T₂ = 0.25 W |
| 4. | ϕ = 45° | τ = 45° | ρ = 20° | T₁ = 0.4532 W, T₂ = 0.2113 W |
| 5. | ϕ = 12° | τ = 12° | ρ = 33° | T₁ = T₂ = 0.3536 W |
| 6. | ϕ = 20° | τ = 20° | ρ = 25° | T₁ = T₂ = 0.3536 W |
| 7. | ϕ = 25° | τ = 25° | ρ = 20° | T₁ = T₂ = 0.3536 W |
| 8. | ϕ = 30° | τ = 30° | ρ = 15° | T₁ = T₂ = 0.3536 W |
| 9. | ϕ = 30° | τ = 30° | ρ = 30° | T₁ = 0.433 W, T₂ = 0.25 W |
| 10. | ϕ = 45° | τ = 45° | ρ = 25° | T₁ = 0.4698 W, T₂ = 0.171 W |

Result-1 indicates that when ϕ and τ are both 45°, the airplane should be able to perform vertical takeoff and landing with pitch angle of 0°, i.e., fuselage in level position and the horizontal propulsors and the vertical propulsors would each generate a thrust that equals approximately 35% of the all-up-weight of the airplane, W. If the takeoff pitch angle ρ is now increased to 30° as shown in Result-9, then each of the vertical propulsors (106) is only expected to output a thrust of 0.25 W in order to sustain a stationary hover. This is an efficient design because apart from providing thrust for vertical flight, the powerful horizontal propulsors (104) can also be used for high-speed cruising. Result-10 is yet another interesting result with pitch angle ρ=25° and T₂=0.171W. Based on the analytical results, τ the tilt angle of the vertical propulsor (106) may be fixed at 45°.

After making transition to horizontal flight mode, the wings (102) and the thrust vectors of the horizontal propulsors (104) may tilt in a continuous but gradual manner to a lower tilt angle, for example 0° with respect to the airplane's longitudinal axis. During horizontal flight, the vertical propulsors (106) may be retracted into the fuselage (101) to improve aerodynamic efficiency.

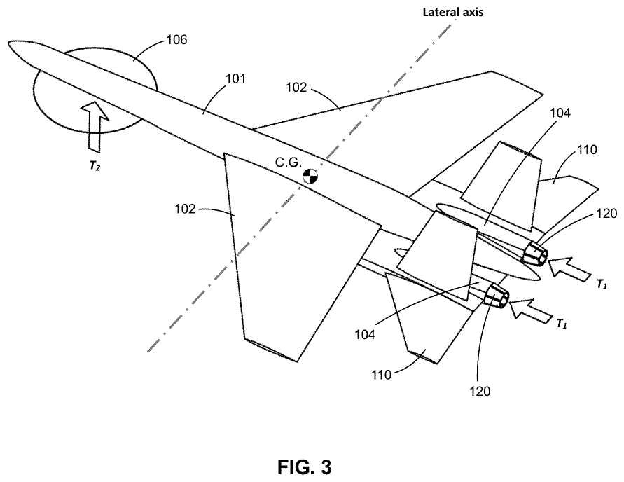

FIG. 3 shows a perspective view of yet another embodiment of the airplane in accordance with the present invention wherein adjustment of the tilt angle of the thrust vector of the horizontal propulsor (104) is achieved by using thrust vectoring nozzle (120). In this exemplary embodiment, each horizontal propulsor (104) comprises a thrust vectoring nozzle (120) capable of two degrees of freedom to actuate roll and yaw controls during takeoff and vertical flight. The vertical propulsor (106) mounted on the front section of the airplane controls the pitch angle of the airplane prior to takeoff and during VTOL flights.

This embodiment is also an example in which the thrust vector of the horizontal propulsor (104) tilts about an axis that is parallel to but does not coincide with the lateral axis.

This embodiment is also suitable for high-speed applications and thus the horizontal propulsors (104) should preferably be of those types capable of propelling the airplane to a high airspeed, for example turbojet, and turbofan.

The foregoing description of the present invention has been presented for purpose of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable other skilled in the art to utilize the invention in such or other embodiments and with various modifications required by the particular application(s) or use(s) of the present invention. It is intended that the appended claims be construed to include alternative embodiments to the extent permitted by the prior art.

### REFERENCES

1. M. Francesco (2020) Is the Urban Air Mobility Industry ready for Take-Off? https://www.airborne.com/urban-air-mobility-the-rise-of-evtol-vehicles/
2. ArduPilot Dev Team (2019) QuadPlane Overview. https://ardupilot.org/plane/docs/quadplane-overview.html
3. Wikipedia (2021) Tiltwing. https://en.wikipedia.org/wiki/Tiltwing
4. Wikipedia (2021) Tiltrotor. https://en.wikipedia.org/wiki/Tiltrotor
5. Wikipedia (2022) Quadcopter. https://en.wikipedia.org/wiki/Quadcopter

1. An airplane configured to perform hyper-short takeoff and landing with a positive pitch angle comprising:
an all-up-weight;
a center of gravity;
a front section located in front of the center of gravity, and a back section located behind the center of gravity;
a longitudinal axis, the longitudinal axis dividing the airplane into a left side and a right side;
a lateral axis;
a vertical axis;
at least one vertical propulsor, the vertical propulsor generates a thrust vector; and
at least a pair of wings, comprising a left wing, and a right wing; wherein the thrust vector of the vertical propulsor has a tilt angle in the range of 0° to 45° relative to the vertical axis when viewed from a side view.

2. The airplane of claim 1, wherein said airplane is configured to perform a hover, and vertical takeoff and landing while assuming a positive pitch angle; said airplane further comprises at least two horizontal propulsors, each horizontal propulsor generates a thrust vector; at least one horizontal propulsor is mounted on the left side, and at least one horizontal propulsor is mounted on the right side; further wherein the thrust vector of the horizontal propulsor is tiltable with a tilt angle that is adjustable in the range of 0° to 76° relative to the longitudinal axis when viewed from a side view; the thrust vector of the horizontal propulsor tilts about an axis that is parallel to the lateral axis.

3. The airplane of claim 1, wherein at least one vertical propulsor is located on the front section of the airplane with the tilt angle fixed at substantially 0° relative to the vertical axis.

4. The airplane of claim 2, wherein at least one vertical propulsor is located on the front section of the airplane with the tilt angle fixed at substantially 0° relative to the vertical axis.

5. The airplane of claim 4, wherein the airplane achieves a hover in null wind when:
the sum of the airplane's pitch angle and the tilt angle of the thrust vector of the horizontal propulsor is substantially 90°;
the sum of the thrust vectors of the horizontal propulsors equals to
the all-up-weight of the airplane; and
the thrust vector of the horizontal propulsor passes through the center of gravity when viewed from a side view.

6. The airplane of claim 2, wherein the vertical propulsor comprises an impeller of variable-pitch.

7. The airplane of claim 2, wherein the vertical propulsor comprises an impeller of fixed-pitch.

8. The airplane of claim 2, wherein the airplane comprises a fuselage, and further wherein the vertical propulsor is retracted into the fuselage during horizontal flight.

9. The airplane of claim 1, wherein airplane comprises a set of main landing gears located on the back section of the airplane; and a nose landing gear located on the front section of the airplane; vertical height of the nose landing gear is adjustable such that the pitch angle of the airplane can be adjusted from 0° to 10°.

10. The airplane of claim 2, wherein airplane comprises a set of main landing gears located on the back section of the airplane; and a nose landing gear located on the front section of the airplane; vertical height of the nose landing gear is adjustable such that the pitch angle of the airplane can be adjusted from 0° to 10°.

11. The airplane of claim 1, wherein the vertical propulsor is ducted.

12. The airplane of claim 2, wherein the vertical propulsor is ducted.

13. The airplane of claim 2, wherein the airplane comprises a horizontal stabilizer for pitch control during horizontal flight.

14. The airplane of claim 2, wherein at least one horizontal propulsor is mounted on the left wing and at least one horizontal propulsor is mounted on the right wing; the wings and the thrust vector of the horizontal propulsor tilt substantially about the lateral axis.

15. The airplane of claim 2, wherein the thrust vector of the horizontal propulsor tilts substantially about the lateral axis.

16. The airplane of claim 1, wherein at least one vertical propulsor is mounted on the back section of the airplane with the tilt angle fixed at substantially 0° relative to the vertical axis.

17. The airplane of claim 2, wherein at least one vertical propulsor is mounted on the back section of the airplane with the tilt angle fixed at substantially 0° relative to the vertical axis.

18. The airplane of claim 1, wherein the airplane comprises a fuselage, at least one vertical propulsor located on the front section of the airplane, and at least one vertical propulsor located on the back section of the airplane.

19. The airplane of claim 2, wherein the airplane comprises a fuselage, at least one vertical propulsor located on the front section of the airplane, and at least one vertical propulsor located on the back section of the airplane.

20. The airplane of claim 19, wherein the shape of the fuselage is generally an ellipsoid.

21. The airplane of claim 19, wherein the tilt angle of the vertical propulsor is fixed at 45°.
